(19) United States
(12) Patent Application Publication
(10) Pub. No.: US 2006/0273490 A1
(43) Pub. Date: Dec. 7, 2006

(54) D.P. foiler

(76) Inventor: Denny Preis, Marthasville, MO (US)

Correspondence Address: Henry W. Cummings, 3313 W. Adams St., St. Charles, MO, 63301, US

(21) Appl. No.: 11/145,885

(22) Filed: Jun. 7, 2005

(51) Int. Cl. B29C 43/02

(52) U.S. Cl. 264/320; 425/399

(57) ABSTRACT

A method and apparatus for making toys comprising: providing a bottom plate containing a male mold in the shape of a desired object to be molded, providing a top plate containing a female mold in the inverse shape of the desired object to be molded, placing at least one foil sheet located between said bottom plate and said top plate, and forcing said bottom plate and said top plate toward each other whereby said shape is formed in said foil sheet; and removing said shape from between said top plate and said bottom plate.

### FIELD OF THE INVENTION

The present invention relates to toys, particularly toy vehicles designed to be impacted by other toy vehicles during play.

### BACKGROUND OF THE INVENTION

During recreational play with toy vehicles, it is often desirable to construct vehicles and other objects whose purpose is to be destroyed in the course of play. Due to the destructive nature of such recreation, it is further desirable that said destructable objects be made of inexpensive, easily replaced, malleable material.

U.S. Pat. No. 4,466,214 discloses an impact responsive toy vehicle. This toy vehicle is made of molded plastic and is designed to flip over upon impacting another object.

U.S. Pat. No. 6,672,937 discloses a miniature toy vehicle that is self-propelled and preferably remote controlled. It is designed to flip another toy vehicle upon contact.

### SUMMARY OF THE INVENTION

### A. Summary

A means for making toy vehicles and other objects comprises a male/female mold unit and a plurality of pre-painted foil sheets.

### B. Objects of the Invention

The objective of the present invention is to provide a means of producing easily crushed vehicles or other items for the purpose of being destroyed during play.

Another object of the present invention is to form said vehicles or other items from a series of pre-decorated metal foil sheets.

Another object of the present invention is to allow the user to form said items from household aluminum foil and to subsequently decorate them as desired.

Other objects of the present invention will become apparent from the following Description and Drawings.

### THE DRAWINGS

FIG. 1 is a perspective view of the present invention.

FIG. 2 is a view of one possible pre-decorated foil sheet.

FIG. 3 is a perspective view of the present invention showing a foil sheet inserted for use.

FIG. 4 is a perspective view of the present invention after the male and female mold halves are brought to bear upon the foil sheet.

FIG. 5 is a view of one possible use of the molded vehicle prior to its being destroyed by a remotely controlled vehicle.

FIG. 6 is a view of one possible use of the molded vehicle in the process of being destroyed by a remotely controlled vehicle.

### DESCRIPTION OF PREFERRED EMBODIMENTS

In accordance with FIG. 1, the present invention is shown generally at 100. Bottom plate 110 contains male mold 120, and is connected to top plate 130 by means of hinge 160. Top plate 130 contains female mold 140 and handle 150. Bottom plate 110 and male mold 120 may be made of metal, wood, or heavy duty plastic. Top plate 130 and female mold 140 may be made of metal, wood, or heavy duty plastic. Hinge 160 and handle 150 may be made of metal, wood, or heavy duty plastic. Male mold 120 and female mold 140 may be configured to replicate the shape of any type of motor vehicle (car, truck, bus, etc.). Other objects likely to provide entertainment include, but are not limited to, buildings, tires, furniture, or any other item.

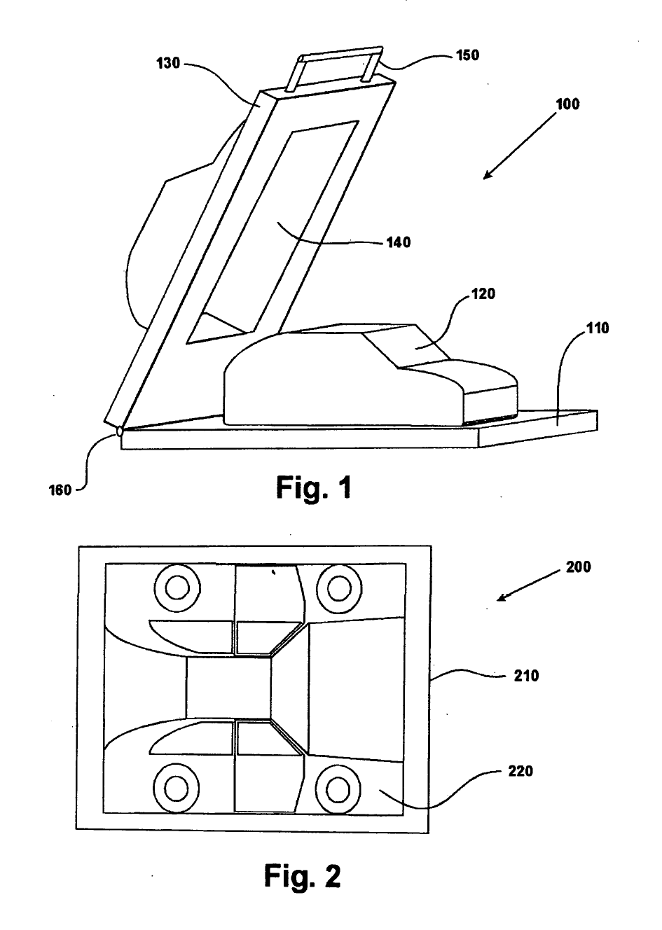

In accordance with FIG. 2, the present invention may also include a pre-decorated foil sheet 200. This sheet is comprised of foil backing 210 and decoration 220. In this example, the decoration is in the form of a car, but may be any object appropriate to the shape of the male and female mold provided. For variety, the user is not limited to the pre-decorated sheet, but may obtain a same-sized piece of common household foil (preferably heavy-duty). The user may then decorate the foil before or after forming the toy by means of using the mold.

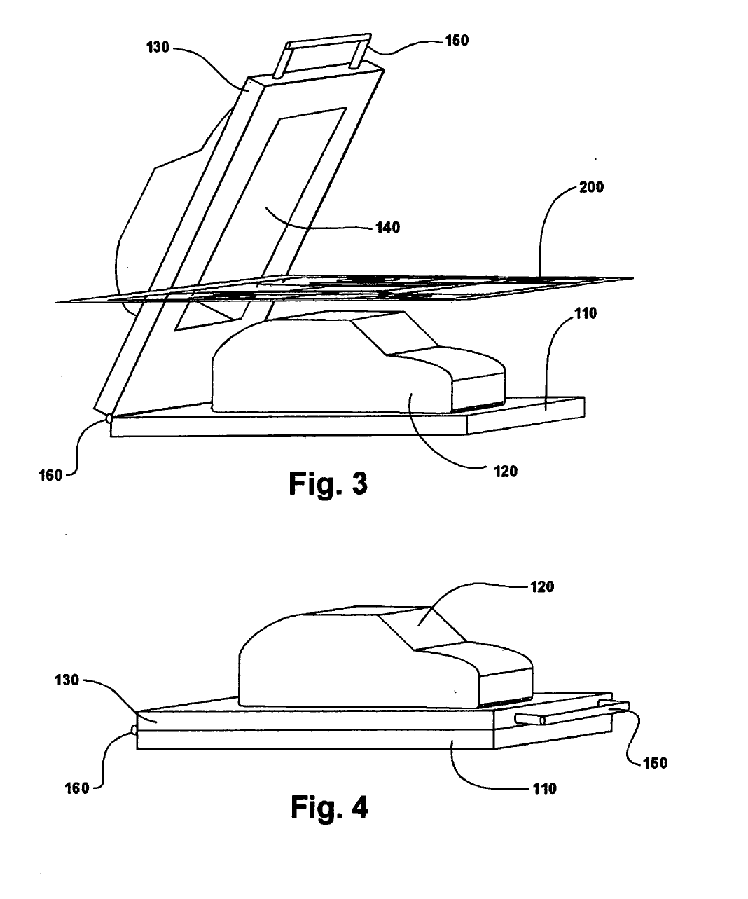

In accordance with FIGS. 3 and 4, a pre-decorated piece of foil 200 is shown between top plate 130 and bottom plate 110. Grasping handle 150, the user closes top plate 130 onto bottom plate 110, capturing foil 200 between male mold 120 and female mold 140.

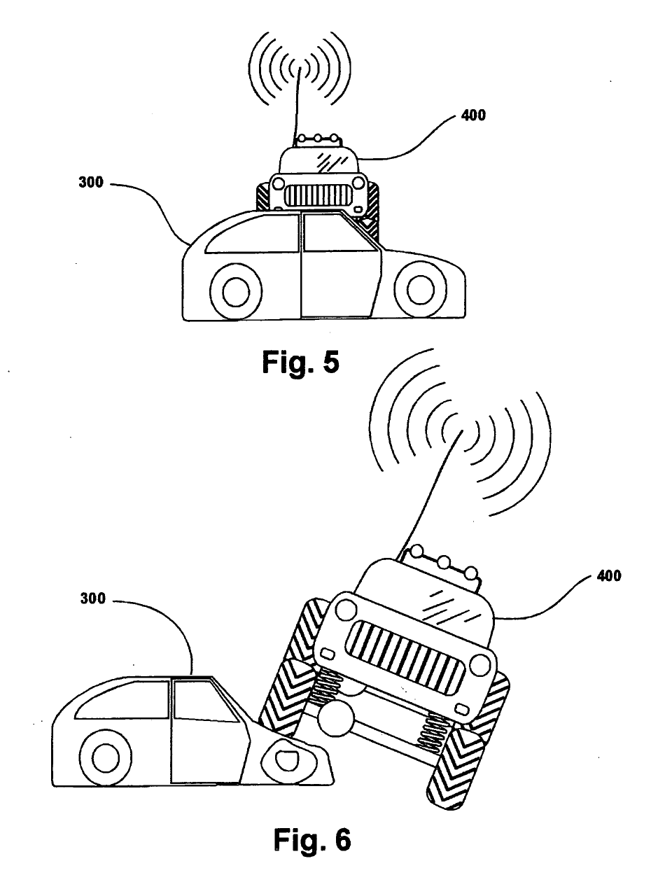

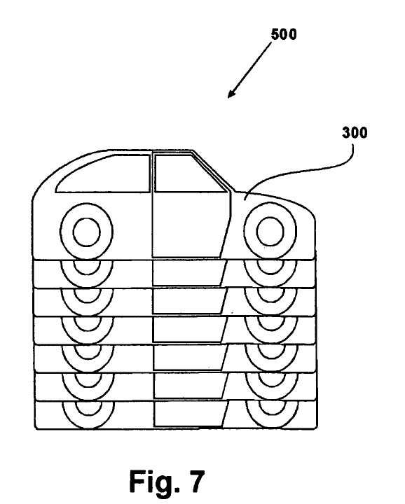

In accordance with FIGS. 5 and 6, the finished toy 300 is shown waiting for the approach of a radio controlled vehicle 400, which is shown crushing toy 300 (FIG. 6).

What is claimed is:

1. A toy-making device comprising:
a bottom plate containing a male mold in the shape of a desired object to be molded
a top plate containing a female mold in the inverse shape of the desired object to be molded,
at least one foil sheet located between said bottom plate and said top plate, and
means for forcing said bottom plate and said top plate toward each other whereby said shape is formed in said foil sheet; and
means for removing said shape from between said top plate and said bottom plate.

2. A toy-making device according to claim 1 wherein said bottom plate is made of a material selected from metal, wood, and heavy duty plastic.

3. A toy-making device according to claim 1 wherein said top plate is made of a material selected from metal, wood, and heavy duty plastic.

4. A toy-making device according to claim 2 wherein said male mold is in the shape of a motor vehicle.

5. A toy-making device according to claim 4 wherein said top plate contains a female mold in the inverse shape of a motor vehicle.

6. A toy-making device comprising:
a bottom plate containing a female mold in the shape of a desired object to be molded
a top plate containing a male mold in the inverse shape of the desired object to be molded,
at least one foil sheet located between said bottom plate and said top plate, and
means for forcing said bottom plate and said top plate toward each other whereby said shape is formed in said foil sheet; and
means for removing said shape from between said top plate and said bottom plate.

7. A toy-making device according to claim 6 wherein said bottom plate is made of a material selected from metal, wood, and heavy duty plastic.

8. A toy-making device according to claim 6 wherein said top plate is made of a material selected from metal, wood, and heavy duty plastic.

9. A toy-making device according to claim 6 wherein said male mold is in the shape of a motor vehicle.

10. A toy-making device according to claim 9 wherein said top plate contains a female mold in the inverse shape of a motor vehicle.

11. A method of making toys comprising:
providing a bottom plate containing a male mold in the shape of a desired object to be molded;
providing a top plate containing a female mold in the inverse shape of the desired object to be molded,
placing at least one foil sheet located between said bottom plate and said top plate, and
forcing said bottom plate and said top plate toward each other whereby said shape is formed in said foil sheet; and
removing said shape from between said top plate and said bottom plate.

12. A method of making toys according to claim 11 wherein said bottom plate is made of a material selected from metal, wood, and heavy duty plastic.

13. A method of making toys according to claim 12 wherein said top plate is made of a material selected from metal, wood, and heavy duty plastic.

14. A toy-making method according to claim 13 wherein said male mold is in the shape of a motor vehicle.

15. A toy-making method according to claim 14 wherein said top plate contains a female mold in the inverse shape of a motor vehicle.

16. A toy-making method comprising:
providing a bottom plate containing a female mold in the shape of a desired object to be molded;
providing a top plate containing a male mold in the inverse shape of the desired object to be molded;
locating at least one foil sheet located between said bottom plate and said top plate, and
forcing said bottom plate and said top plate toward each other whereby said shape is formed in said foil sheet; and
removing said shape from between said top plate and said bottom plate.

17. A toy-making method according to claim 16 wherein said bottom plate is made of a material selected from metal, wood, and heavy duty plastic.

18. A toy-making device according to claim 17 wherein said top plate is made of a material selected from metal, wood, and heavy duty plastic.

19. A toy-making method according to claim 18 wherein said male mold is in the shape of a motor vehicle.

20. A toy-making method according to claim 19 wherein said top plate contains a female mold in the inverse shape of a motor vehicle.
